(19) United States
(12) Patent Application Publication
(10) Pub. No.: US 2003/0187774 A1
(43) Pub. Date: Oct. 2, 2003

(54) Auction scheduling

(76) Inventors: Krishna Kummamuru, New Delhi (IN); Raghuram Krishnapuram, New Delhi (IN); Manoj Kumar, Yorktown Heights, NY (US)

Correspondence Address: McGinn & Gibb, PLLC, 2568-A Riva Road, suite 304, Annapolis, MD, 21401, US

(21) Appl. No.: 10/114,723

(22) Filed: Apr. 1, 2002

(51) Int. Cl. G06F 17/60

(52) U.S. Cl. 705/37

(57) ABSTRACT

A set of auctions is divided into groups of auctions such that the chances of finding interesting auctions across the groups of auctions by a bidder are minimized. These groups of auctions can scheduled such that the chances of auctions of interest to bidders (and prospective bidders) held in the same time slot or are either minimised or maximized.

### FIELD OF THE INVENTION

The present invention relates to auctions and relates particularly, though not exclusively, to auctions conducted online using the Internet, and the scheduling of such auctions.

### BACKGROUND

An auction is a public sale at which property or goods are sold to the highest bidder. In this respect, an auction can be thought of as a market mechanism for determining the price of an item. Usually, the item is sold to the highest bidder. Auctions are effectively defined by a predetermined set of rules governing the auction mechanism, the product or service that is being auctioned, and by other various parameters of the auction such as reserve prices, and duration etc.

In case of Internet auctions, the auctioneer communicates or publicises the progress of the auction (the current leading bids, anticipated closing time, etc) via the Internet, typically from a particular Web site.

One of the issues facing online auctioneers is the ability to effectively schedule when auctions are conducted. Wellman et al (Michael P Wellman and Peter R Wurman, Real Time Issues in Internet Auctions, First IEEE Workshop on Dependable and Real-time E-commerce Systems (DARE-98), Denver, Colo., United States, June 1988) have studied auction scheduling techniques that balance the load on multiple servers.

In the case of Internet auctions, an auctioneer typically conducts a large number of auctions during a given period of time. Scheduling a large number of auctions at once causes the following problems: (i) high levels of network traffic to the auction server; and (ii) reduced participation as users' responsiveness is limited by the need to browse and/or search through a large number of auctions at a time.

In view of the above, a need clearly exists for an improved manner of scheduling auctions that at least attempts to address one or more limitations of the prior art.

### SUMMARY

Clear and apparent advantages are available by appropriately scheduling auctions. In particular, it is recognised that auctions are advantageously scheduled in a manner that increases the average chances of auctions of interest to a bidder (and prospective bidder) being scheduled at the same time (or same time slot). In other words, it is desirable that the chances of finding interesting auctions across the groups of auctions by a bidder are minimized.

Appropriate grouping of auctions allows auctions to be scheduled during non-overlapping or at most partially overlapping periods of time. Appropriate scheduling reduces the participation cost of bidders. That is, once appropriate groups are determined, the resulting groups are used to suitably schedule the auctions based on these identified groups.

It is recognised that auctions can be desirably clustered or grouped into groups for scheduling by representing auctions as data that can be interpreted by cluster analysis techniques to form non-hierarchical groups of auctions. Division of auctions into groups is performed based on data that represents bidders' respective interests in various auctions. A predetermined number of auction groups can be specified. Alternatively, a lower bound on the fraction of bidders interested in multiple auctions from a particular group of auctions can be specified. A hybrid approach, for determining the number of auction groups, can also be adopted.

### DESCRIPTION OF DRAWINGS

FIG. 1 is a schematic representation of a system, involving two modules (a data preparation module and a cluster module), used for grouping auctions in accordance with the techniques described herein.

FIG. 2 is a schematic representation of the data preparation module used in the system of FIG. 1.

FIG. 3 is a schematic representation of a relationship computation module that is part of the data preparation module of the system of FIG. 1.

FIG. 4 is a flowchart that represents the steps performed by the cluster module of the system of FIG. 1.

FIG. 5 is a schematic representation of a computer system suitable for performing the described techniques provided by the system of FIG. 1.

### DETAILED DESCRIPTION

A method, computer system and computer software are described for scheduling auctions using an approach that involves appropriately grouping the auctions to be scheduled.

In essence, determining an appropriate grouping of auctions involves finding clusters in a data set with respect to a given relation. Each of the auctions is considered as a data point (for example, in the set {a₁, a₂, . . . aₙ}), and auction aᵢ is related to auction aⱼ. This relationship defined between auction pairs (aᵢ, aⱼ) depends on the objective of the proposed auction grouping: it may be a symmetric or asymmetric relationship. The objective is to group auctions such that for any given bidder, the chances of finding interesting auctions in two or more different groups of auctions are minimized. To this end, a relation that reflects the average interest that a bidder interested in auction aᵢ has in auction aⱼ is considered. However, note that this relation is asymmetric (that is, R(aᵢ, aⱼ) g R(aⱼ, aᵢ)). Techniques for estimating this relation are described in the section entitled “Relation computation module”.

A technique for solving the data clustering problem noted above is addressed in two steps. In a first step, data points (corresponding with auctions) are evaluated for their ability to form a cluster. This evaluation is referred to as the “lead value” of the data point. One way of computing the lead value of an auction involves determining the number of users interested in the auction. A second step consists of actually determining proposed auction grouping, given the lead values of the data points and the relations between them.

The two-step process referred to the above is implemented by respective modules. The first module, referred to as the data preparation module, converts data relating to auctions and users (that is, profiles and bidding history) into data used in clustering analysis. The second module, referred to as the clustering module, uses this data to cluster the auctions.

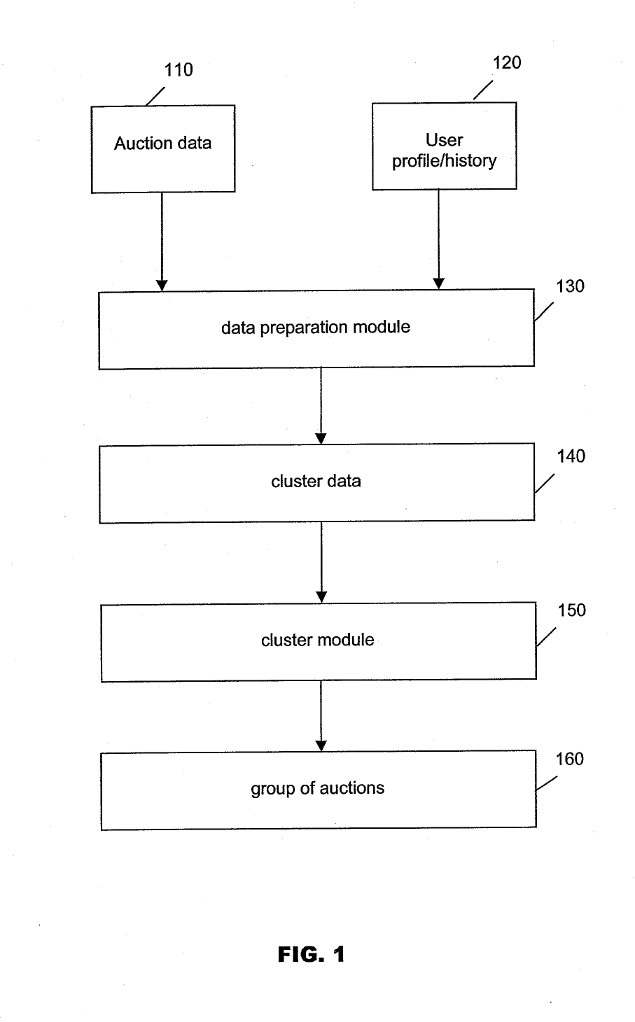

FIG. 1 schematically represents these two modules, and the process associated with these modules. In overview, auction data 110 and user profile/history data 120 are both input to the data preparation module 130. The data preparation module 130 outputs cluster data 140, which is then input to the cluster module 150. Based on the cluster data 140, the cluster module 150 provides a group of auctions 160 that can be used for scheduling purposes.

These two modules are described in detail below under respective sections entitled “data preparation module” and “clustering module”.

Data Preparation Module

The first module uses the following three sub-modules (namely an interest prediction module, a relationship computation module and a lead value computation module):

1. Interest prediction module: The interest prediction module maps an auction aᵢ to an interest vector aᵢ of dimension equal to the number of m bidders. Each element of the interest vector as represents the degree of interest of the corresponding bidder in the respective auction aᵢ. Accordingly, the interest prediction module produces a set of interest vectors {a₁, a₂, . . . a_{N}}, members of which correspond with respective members of the set of auctions {a₁, a₂, . . . a_{N}}.

This interest prediction module outputs a binary interest vector aᵢ where the i-th element (corresponding with a respective bidder) is: (i) 1 if the i-th bidder has bid at least once for the item to be auctioned in auction aᵢ (that is, it is inferred that the bidder is interested in this auction aᵢ: the bidder has not cast a dummy bid); and is (ii) 0 otherwise. A more sophisticated version of this interest prediction module outputs an interest vector aᵢ containing numbers in the range [0,1] that reflect the extent of bidders' interests in auction items.

2. Relationship computation module: The relationship computation module computes the relationship between respective pair of auctions aᵢ and aⱼ and returns a relationship matrix R that specifies the average correlation in interest between all pairs of auctions aᵢ and aⱼ. That is, the ij-th element rᵢⱼ of the relationship matrix R represents the average interest of a bidder interested in auction aᵢ towards auction aⱼ.

Assuming that the auctions {a₁, a₂, . . . a_{N}} are represented by binary interest vectors {a₁, a₂, . . . a_{N}} generated in the interest prediction module, the relationship computation module computes rᵢⱼ as |aᵢ·aⱼ|/|aᵢ|, where |a| is the sum of elements of the vector a. This expression for rᵢⱼ can also be used to compute the relationship matrix R for non-binary interest vectors {a₁, a₂, . . . a_{N}} (for example, vectors having elements that are numbers in the range [0,1]). More sophisticated computations can also be used. For example, rᵢⱼ could be |aᵢ·aⱼ|/|aᵢ| where the intersection is a fuzzy intersection.

3. Lead value computation module: Each auction aᵢ is evaluated for its ability to lead a cluster. Various measures that reflect an auction's ability to lead a cluster can be used. For example, the lead value of an auction can be the number of users interested in the item that is being auctioned. That is, the lead value of auction aᵢ is |aᵢ|. Alternatively, other indicators or measures can be used. For example, the lead value of an auction could be the profit earned by selling the item at the reserved price of the item. This lead value is used in the clustering module described below.

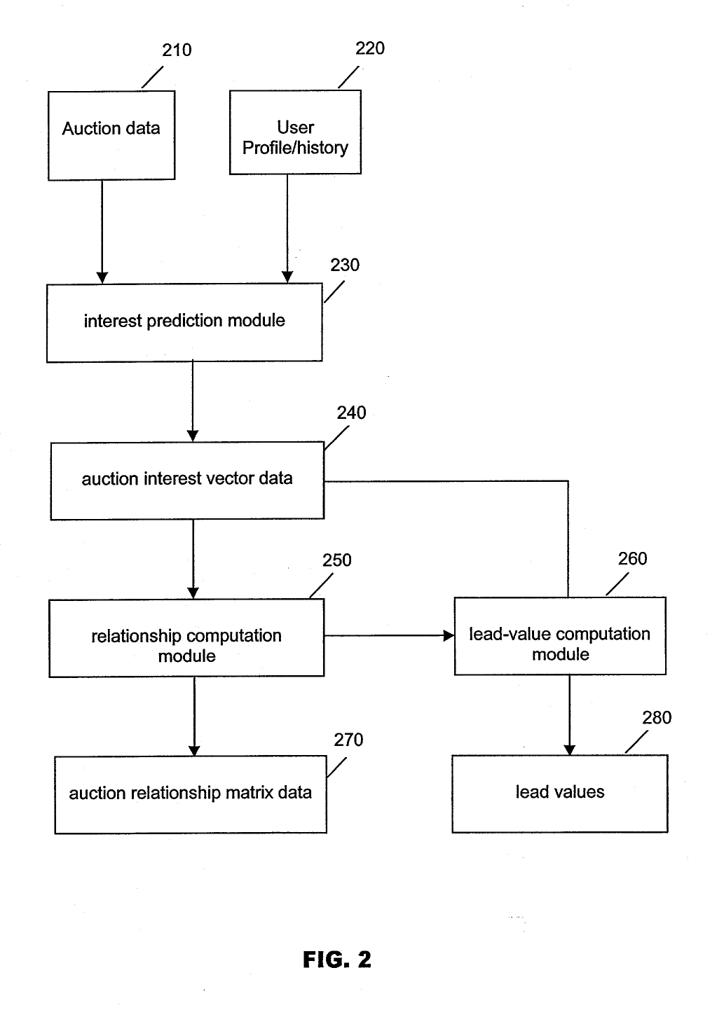

FIG. 2 schematically represents the operation of the data preparation module 130 as described above with reference to FIG. 1. In summary, the auction 210 and user profile/history data 220 are input to the interest prediction module 230 to produce auction interest vector data 240. This auction interest vector data 240 is supplied both to the relationship computation module 250 and the lead value computation module 260. The lead value computation module 250 computes lead values 280 from the auction interest vector data 240, with input from the relationship computation module 250. The relationship computation module 250 computes auction relationship matrix data 270 from the auction interest vector data 240.

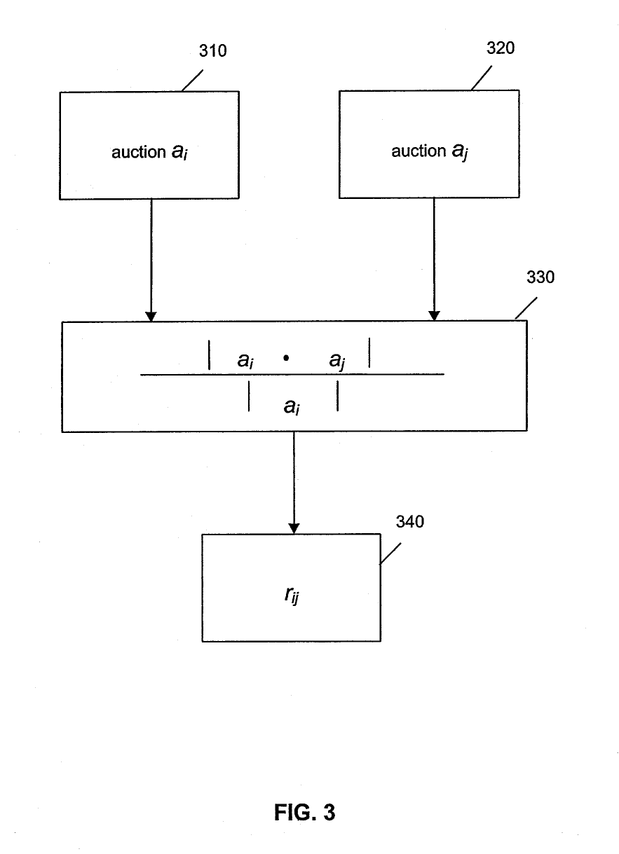

FIG. 3 schematically represents the operation of the relationship computation module 250 as described above with reference to FIG. 2. Values as aᵢ 310 and aⱼ 320 are supplied for respective auctions associated with indices i and j. These values are used to calculate the expression |aᵢ·aⱼ|/|aᵢ| 330, which is used in determining the auction relationship matrix rᵢⱼ 340.

Clustering Module

The clustering problem under consideration is first defined before describing the clustering method per se.

The set of auctions A={a₁, a₂, . . . a_{N}} represents the auctions to be scheduled.

The set of interest vectors D={a₁, a₂, . . . a_{N}} is formed with respect to m bidders That is, each interest vector aᵢ is an m-dimensional vector in which elements of interest vector aᵢ, represent the extent of interest of bidders in the i-th auction aᵢ.

The relationship matrix R represents the relation between any two auctions.

Partition P={Cᵢ} is a set of non-empty disjoint sets Cᵢ, of the set of auctions A that represents a way in which the set of auctions A can be clustered.

The set of lead values L:D→R (R is the set of all real numbers). That is, L maps each auction to a real number that represents its lead value.

The number η is a threshold value specified by the user.

The objective is to find a partition {Cᵢ} (that is, a set of non-empty disjoint sets) of the set of auctions A satisfying the following conditions:

1. For all pairs of auctions aᵢ, aₘ that are members of a cluster Cᵢ of partition {Cᵢ}, all corresponding elements rₗₘ of R is greater than η; and

2. The cardinality of {Cᵢ} (that is, the number of member sets of {Cᵢ}) is as small as possible.

In other words, the task is to find as few clusters as possible such that for every pair (aᵢ, aₘ) of auctions in each of the clusters, the average interest of a bidder interested in action aₗtowards aₘ is greater than η.

The described techniques provide a heuristic algorithm that results in a relatively close approximation to the problem described above.

Proposed Algorithm

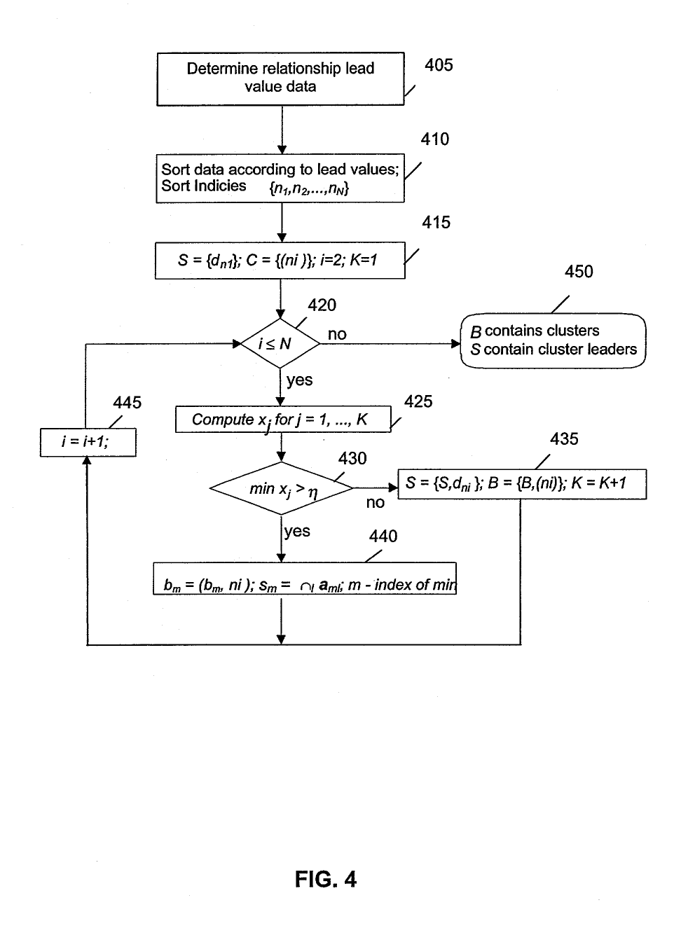

FIG. 4 schematically represents the process involved in forming clusters Cᵢ and a partition of the set of auctions A. Relationship and lead value data is first determined in step 405. The auctions are sorted in step 410 according to their lead values, to provide sorted indices {n₁, n₂, . . . n_{N}} in descending order of their lead values. In step 415, the set S of cluster representatives and the array B of vectors containing the indices of auctions in the clusters are initialized to {aₙ₁} and [(n₁)] respectively, and, i and K are initialized to 2 and 1 respectively.

At step 420, it is checked whether i is less than or equal to N. If the value of i is less than N, the value xⱼ is computed for each value of j from 1 to K in step 425 as follows:

if (|aₙᵢ·sⱼ|>hⱼ·η) xⱼ=R(aₙᵢ, sⱼ);

else xⱼ=infinity;

In the above computation:

sⱼ represents the j-th cluster representative in the set S,

hⱼ represents the maximum number of bidders interested in any of the auctions in the j-th cluster, and

the relation R between any two auction R(a,b) is given by |a·b|/|a|.

It is then determined, in step 430, if the minimum value of xⱼ is greater than a predetermined minimum threshold value η.

If the minimum value of xⱼ exceeds this predetermined minimum η in step 430, then bₘ (bₘ is the m-th vector in array B) and Sₘ are updated in step 440 as below, where m is the value of the index that corresponds to the minimum value of xⱼ:

bₘ=(bₘ, nᵢ), and

sₘ=∩ₗaₘₗ

where, aₘₗ is the l-th auction in the m-th cluster. That is, sₘ is the intersection of all auctions in the j-th cluster.

If the minimum value of xⱼ does not exceed this predetermined minimum η, then sets S and B are updated, in step 435, with new values according to the relation S={S, aₙᵢ} and B={B, (ni)}. Also, K is incremented to K+1.

Irrespective of the minimum value of xⱼ, the index i is incremented to i+1, in step 445, and the process repeats from step 420.

Steps 425 to 445 are repeatedly performed for incrementing values of i, until i is greater than N. In this case, the process of steps 425 to 445 is stopped, and the end results for sets B and S obtained in step 450.

In summary, the auction with the highest lead value is made a member of the first cluster. Then, each of the remaining auctions, taken in the descending order of their lead values, is assigned to either an existing cluster or a new cluster. An auction is assigned to the cluster corresponding to the nearest among the representatives of the clusters if the auction's relationship with the nearest representative is greater than a predetermined threshold. An auction is made a representative of a new cluster if the auction's relationship with members of each of the existing clusters is less than the given threshold value.

A cluster representative can be considered to be the centroid of the cluster and is found by taking the commonality of all the auctions in the cluster. If auctions are represented by binary vectors, then the cluster representative is the vector representing the set of users who are interested in all the auctions in the cluster. A similar fuzzy intersection can be used in the case in which the auctions are represented by non-binary vectors.

The following observations show that all clusters obtained using the described techniques satisfy the first condition above (that is, for aₗ, aₘεCᵢ, R(aₗ, aₘ)>η).

Let C={c₁, c₂, . . . cₘ}, in which c is a set of binary vectors, and let c represent the vector resulting from a bit-wise AND operation on all the vectors in C. Then, for any binary vector a, |a·c|/|a|<|a·cᵢ|/|a|, for i=1, . . . m.

As a consequence, if |a·c|/|a|>η, then |a·cᵢ|/|a|>η, for i=1, . . . m.

Let the set C be such that R(cᵢ, cⱼ)=|cᵢ·cⱼ|/|ci|>η for all i, j. Then, the set C′={c₁, c₂, . . . cₘ, a} retains the above property (that is R(cᵢ, cⱼ)=|cᵢ·cⱼ|/|cᵢ|>η for all cᵢ, cⱼεC′.), if |a·c|≧max |cᵢ|·η. This is so, because R(cᵢ, a)=|a·cᵢ|/|cᵢ|≧η for all i.

Pseudo-Code

A pseudo-code representation of described technique is given directly below. In the pseudo-code, text following double slash marks (that is, “//”) denotes comments that are not part of the pseudo-code, but serve to provide explanatory explanation to the pseudo-code.

1. Sort auctions in decreasing order of their lead values. Let the sorted index set be I={n₁, n₂, . . . n_{N}}.

2. Initialize S, the set of cluster representatives. Let B be an array of vectors of variable length whose elements represent the indices of auctions in Cᵢ. Denote the i-th element (vector) of B by bᵢ and the j-th element of S by sⱼ. Let B=[(n₁)], S={s₁}={aₙ₁}, and i=2.

3. Build S.

while i < N, {
for j = 1 to |S|, // |S| − cardinality of S

if (|aₙᵢ · sⱼ| > hⱼ · η)
// hⱼ represents the maximum number of bidders interested
// in any of the auctions in j^{th} cluster

xⱼ = R(aₙᵢ, sⱼ);

| | else xⱼ = infinity, |
|---|---|
| if (min xⱼ > η) { | |
| | m = arg min xⱼ; |
| | bₘ = (bₘ, nᵢ); |
| | isNewMember = false; |
| | sₘ = representative(aₘ); // finds a new representative of aₘ |
| } | |
| else | { |

A = [A , (nᵢ)];
S = S ∪ {aₙᵢ};
}

i = i + 1;
}

Computer Hardware and Software

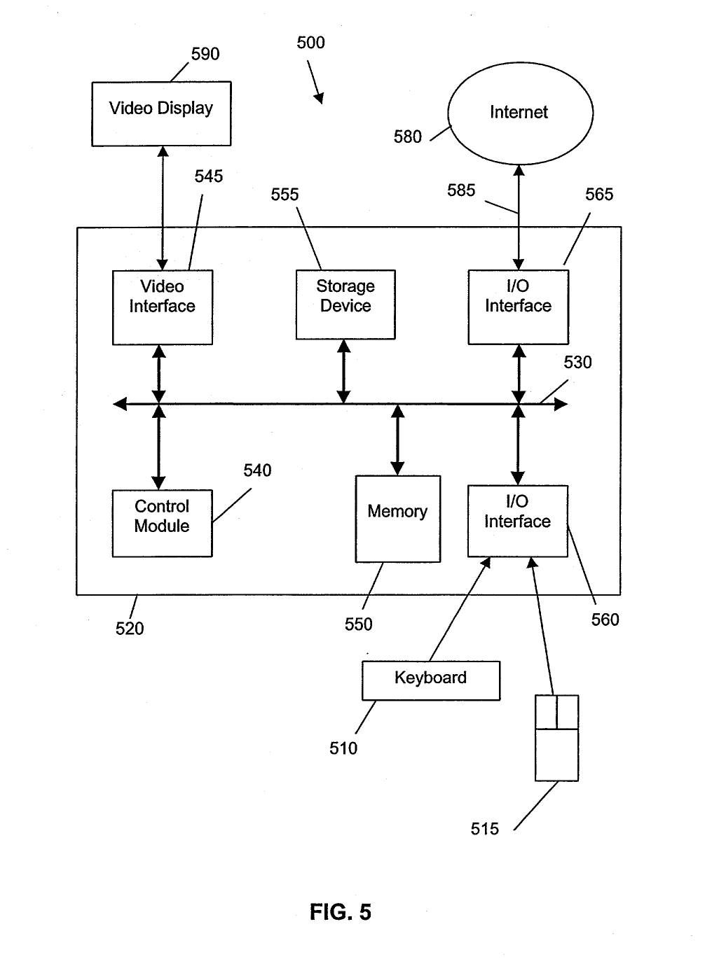

FIG. 5 is a schematic representation of a computer system 500 that can be used to perform steps in a process which implements the techniques described herein. The computer system 500 is provided for executing computer software that is programmed to assist in performing the described techniques. This computer software executes under a suitable operating system installed on the computer system 500.

The computer software involves a set of programmed logic instructions that are able to be interpreted by the computer system 500 for instructing the computer system 500 to perform predetermined functions specified by those instructions. The computer software can be an expression recorded in any language, code or notation, comprising a set of instructions intended to cause a compatible information processing system to perform particular functions, either directly or after conversion to another language, code or notation.

The computer software is programmed by a computer program comprising statements in an appropriate computer language. The computer program is processed using a compiler into computer software that has a binary format suitable for execution by the operating system. The computer software is programmed in a manner that involves various software components, or code means, that perform particular steps in the process of the described techniques.

The components of the computer system 500 include: a computer 520, input devices 510, 515 and video display 570. The computer 520 includes: processor 540, memory module 550, input/output (I/O) interfaces 560, 565, video interface 545, and storage device 555.

The processor 540 is a central processing unit (CPU) that executes the operating system and the computer software executing under the operating system. The memory module 550 includes random access memory (RAM) and read-only memory (ROM), and is used under direction of the processor 540.

The video interface 545 is connected to video display 590 and provides video signals for display on the video display 570. User input to operate the computer 530 is provided from input devices 510, 515 consisting of keyboard 510 and mouse 515. The storage device 555 can include a disk drive or any other suitable non-volatile storage medium. Each of the components of the computer 520 is connected to a bus 530 that includes data, address, and control buses, to allow these components to communicate with each other via the bus 530.

The computer system 500 can be connected to one or more other similar computers via a input/output (I/O) interface 565 using a communication channel 585 to a network 580, represented as the Internet.

The computer software program may be provided as a computer program product, and recorded on a portable storage medium. In this case the computer software program is accessed by the computer system 500 from the storage device 562. Alternatively, the computer software can be accessed directly from the network 580 by the computer 520. In either case, a user can interact with the computer system 500 using the keyboard 510 and mouse 515 to operate the programmed computer software executing on the computer 520.

The computer system 500 is described for illustrative purposes: other configurations or types of computer systems can be equally well used to implement the described techniques. The foregoing is only an example of a particular type of computer system suitable for implementing the described techniques.

### CONCLUSION

A method, system and computer software are each described above for grouping auctions for the purposes of appropriately scheduling the grouped auctions.

In the above described example, auction data is assumed to relate only to auctioned items, and user data is assumed to relate only to items for which the user has bid in the past. However, more complex application of the described techniques is possible, with appropriate modification to the various described processes involved in the two modules.

For example, in the case of user data, greater weight can be attached to items that have been actually bought by a user, compared to items for which only bids have been received from a user.

It is understood that various alterations and modifications can be made to the techniques and arrangements described herein, as would be apparent to one skilled in the relevant art.

We claim:

1. A method for grouping a plurality of auctions into multiple groups based on interest in items offered at the auctions, the method comprising the steps of:
defining a set of interest vectors {a₁, a₂, . . . a_{N}} having N interest vectors aᵢ of dimension m, for which elements of the N interest vectors aᵢ are representive of the interest of m participants in respective corresponding auctions {a₁, a₂, . . . a_{N}};
calculating, from the set of interest vectors {a₁, a₂, . . . a_{N}}, a relationship matrix R of dimension N×N, for which elements rᵢⱼ of the N×N relationship matrix R are representive of the relative correlation between pairs of interest vectors aᵢ and aⱼ for respective auctions aᵢ and aⱼ from the set of auctions {a₁, a₂, . . . a_{N}}; and
performing cluster analysis on the basis of said relationship matrix R to form a partition P ({Cᵢ}) that groups the auctions {a₁, a₂, . . . a_{N}} into clusters Cᵢ of auctions.

2. The method as claimed in claim 1, wherein said clusters of auctions Cᵢ are not hierarchially ordered.

3. The method as claimed in claim 1, wherein said elements of the interest vectors aᵢ are defined based on one or more of the following types of information:
(a) participant behaviour information; and
(b) participant profile information.

4. The method as claimed in claim 3, wherein said participant profile information comprises information that classifies participants into respective categories.

5. The method as claimed in claim 4, wherein the bidder categories are representative of a style of participant behaviour.

6. The method as claimed in claim 3, wherein said participant behaviour information comprises information relating to bid(s) and/or purchase(s) previously made by participants.

7. The method as claimed in claim 1, wherein said elements of the interest vectors aᵢ are defined as binary values.

8. The method as claimed in claim 1, wherein said elements of the interest vectors aᵢ are defined as values within a predetermined range.

9. The method as claimed in claim 1, wherein said elements of the interest vectors aᵢ are defined as binary value representative of whether the respective participant has previously bought the respective item being auctioned.

10. The method as claimed in claim 1, wherein said elements of the interest vectors aᵢ are defined as values that are calculated based on one or more of the following factors: (i) the time since a respective participant last bid for and/or purchased the respective item; (ii) the frequency with which a respective participant has bid for and/or purchased the respective item; and (iii) the monetary value at which a respective participant has bid for and/or purchased the respective item.

11. The method as claimed in claim 1, wherein said elements of the relationship matrix R are calculated as the average correlation of participant interest in respective auctions.

12. The method as claimed in claim 1, wherein said elements of the relationship matrix R are calculated as rᵢⱼ=|aᵢ·aⱼ|/|aᵢ|.

13. The method as claimed in claim 1, further comprising the steps of:
evaluating the ability of an auction to represent or lead a cluster of auctions;
ranking auctions in descending order of lead values;
assigning the auction with the top lead value as the leader or representative of an initial cluster;
assigning, in descending ranked order of lead values, each subsequent auction to: (i) an existing cluster; or (ii) a new cluster; and
determining a similarity measure of how closely each subsequent auction relates to the or each of the existing clusters.
wherein the subsequent auctions are assigned to an existing or new cluster depending on whether said similarity measure is above or below a predetermined threshold value.

14. The method as claimed in claim 13, wherein the predetermined threshold value is: (i) explicitly assigned, or (ii) determined from a predetermined total number of clusters to be formed.

15. The method as claimed in claim 13, further comprising the step of:
selecting, for one or more clusters, auctions representative of respective clusters on the basis of the fuzzy intersection of sets representing the auctions in the respective clusters.

16. The method as claimed in claim 13, wherein the lead values are computed on the basis of the number of participants interested in the auctions of the respective clusters.

17. The method as claimed in claim 13, wherein the lead values are computed on the basis of the profit generated by selling items at the respective reserve prices of the auctions.

18. The method as claimed in claim 1, further comprising the step of:
scheduling said groups of auctions at different time slots such that the chances of participants finding interesting auctions across different time slots are minimized.

19. The method as claimed in claim 1, wherein the interest vectors aᵢ represent participants' interest with respect to their profiles, and such that the j-th dimension of aᵢ is representive of the interest of participants with the j-th profile towards the auctions.

20. A method for grouping a plurality of auctions, the method comprising the steps of:
assigning interest values representative of participant's interest in auctions;
calculating interest correlation measures for associated pairs of auctions based on said interest values; and
performing cluster analysis on the basis of said interest correlation measures to cluster the auctions into respective groups of auctions.

21. A method for scheduling a plurality of auctions, the method comprising the steps of:
assigning interest values representative of participant's interest in auctions;
calculating interest correlation measures for associated pairs or auctions based on said interest values;
performing cluster analysis on the basis of said interest correlation measures to cluster the auctions into respective groups of auctions; and
scheduling the plurality of auctions based on the respective groups of auctions.

22. The method as claimed in claim 21, wherein auctions in the same respective groups are scheduled to occur at the same time, and auctions in different respective groups are scheduled to occur at different times.

23. The method as claimed in claim 21, wherein auctions from different respective groups are scheduled to not occur at the same time.

24. The method as claimed in claim 21, wherein the extent to which auctions from different respective groups are scheduled to occur at the same time is minimised.

25. The method as claimed in claim 21, wherein the auctions that are grouped in the same respective group are scheduled to occur at least partly at the same time.

26. A computer software program, recorded on a medium and capable of execution by a computer system able to interpret the computer program, for grouping a plurality of auctions into multiple groups based on interest in items offered at the auctions, the computer program comprising:
code means for defining a set of interest vectors {a₁, a₂, . . . a_{N}} having N interest vectors aᵢ of dimension m, for which elements of the N interest vectors aᵢ are representive of the interest of m participants in respective corresponding auctions {a₁, a₂, . . . a_{N}};
code means for calculating, from the set of interest vectors {a₁, a₂, . . . a_{N}}, a relationship matrix R of dimension N×N, for which elements rᵢⱼ of the N×N relationship matrix R are representive of the relative correlation between pairs of interest vectors aᵢ and aⱼ for respective auctions aᵢ and aⱼ from the set of auctions {a₁, a₂, . . . a_{N}}; and
code means for performing cluster analysis on the basis of said relationship matrix R to form a partition P ({Cᵢ}) that groups the auctions {a₁, a₂, . . . a_{N}} into clusters Cᵢ of auctions.

27. A system for grouping a plurality of auctions into multiple groups based on interest in items offered at the auctions, the system comprising:
means for defining a set of interest vectors {a₁, a₂, . . . a_{N}} having N interest vectors aᵢ of dimension m, for which elements of the N interest vectors aᵢ are representive of the interest of m participants in respective corresponding auctions {a₁, a₂, . . . a_{N}};
means for calculating, from the set of interest vectors {a₁, a₂, . . . a_{N}}, a relationship matrix R of dimension N×N, for which elements rᵢⱼ of the N×N relationship matrix R are representive of the relative correlation between pairs of interest vectors aᵢ and aⱼ for respective auctions aᵢ and aⱼ from the set of auctions {a₁, a₂, . . . a_{N}}; and
means for performing cluster analysis on the basis of said relationship matrix R to form a partition P ({Cᵢ}) that groups the auctions {a₁, a₂, . . . a_{N}} into clusters Cᵢ of auctions.

28. A computer software program, recorded on a medium and capable of execution by a computer system able to interpret the computer program, for grouping a plurality of auctions, the computer program comprising:
code means for assigning interest values representative of participant's interest in auctions;
code means for calculating interest correlation measures for associated pairs of auctions based on said interest values; and
code means for performing cluster analysis on the basis of said interest correlation measures to cluster the auctions into respective groups of auctions.

29. A computer software as claimed in claim 28, further comprising: code means for scheduling the plurality of auctions based on the respective groups of auctions.

30. A system for grouping a plurality of auctions, the system comprising:
means for assigning interest values representative of participant's interest in auctions;
means for calculating interest correlation measures for associated pairs of auctions based on said interest values; and
means for performing cluster analysis on the basis of said interest correlation measures to cluster the auctions into respective groups of auctions.
